(19) United States
(12) Patent Application Publication
(10) Pub. No.: US 2011/0299818 A1
(43) Pub. Date: Dec. 8, 2011

(54) METHOD AND APPARATUS FOR MECHANICALLY SPLICING TWO OPTIC FIBERS

(75) Inventors: Brent David Allwood, Buttaba (AU); Brett Hoe Slater, Mount Colah (AU); Bryce Nicholls, Green Point (AU)

(73) Assignee: ADC GmbH, Berlin (DE)

(21) Appl. No.: 13/152,749

(22) Filed: Jun. 3, 2011

(30) Foreign Application Priority Data
Jun. 4, 2010 (AU) 2010202338

(51) Int. Cl. G02B 6/255

(52) U.S. Cl. 385/99

(57) ABSTRACT

Apparatus for mechanically splicing two optic fibers, including a housing member having opposed first and second optic fiber receiving sections separated by an optic fiber splicing section; a clamping section having first and second optic fiber restraining members and a splice restraining member overlying respective ones of the first and second optic fiber receiving sections and the optic fiber splicing section, wherein the clamping section is movable between an optic fiber receiving position whereby optic fibers can be inserted into respective optic fiber receiving sections so that optic fiber cores of said optic fibers are in optical communication in the splicing section, and an optic fiber securing position whereby said optic fibers are held by frictional engagement between said optic fiber receiving sections and said restraining members.

This application claims benefit of Serial No. 2010202338, filed 4 Jun. 2010 in Australia and which application is incorporated herein by reference. To the extent appropriate, a claim of priority is made to the above disclosed application.

### TECHNICAL FIELD OF THE INVENTION

The present invention relates to a method and apparatus for mechanically splicing two optic fibers.

### BACKGROUND OF THE INVENTION

An optical connection between optic fibers can be effected by fusion or mechanical splicing. In general, fusion splicing involves joining two optic fibers end-to-end and effecting optical connection using heat. Whereas mechanical splicing involves holding two optic fibers in alignment so that light can pass from one to another.

Previously, the equipment used to effect fusion splicing has been cumbersome and relatively expensive. Further the equipment has not been readily portable. As such, it may not be easy for a technician to effect fusion splicing on site, or in places with restricted space.

Mechanical fiber splicing is typically effected passively or actively. Passive alignment relies on precision reference surfaces, grooves or cylindrical holes, to align fiber cores during splicing. Active alignment typically involves the use of light for accurate fiber alignment. For example, active alignment involves the step of either aligning the fibers through monitoring loss through the splice during alignment, or by using a microscope to accurately align the fiber cores for splicing. To monitor loss, either an optical source and optical power meter or an optical time domain reflectometer (OTDR) are used.

In many circumstances, the above-described splicing methods either produce inaccurate results or take too long to precisely align optic fibers. As such, the techniques may not be useful in the field. Also, human error is prevalent in splicing operations performed in the field (i.e. splices made in cables mounted to telegraph poles) due to movement of the operator, time pressures, or simply due to the degree of accuracy required to ensure a precise splice.

It is generally desirable to overcome or ameliorate one or more of the above mentioned difficulties, or at least provide a useful alternative.

### SUMMARY OF THE INVENTION

In accordance with one aspect of the invention, there is provided an apparatus for mechanically splicing two optic fibers, including:
(a) a housing member having opposed first and second optic fiber receiving sections separated by an optic fiber splicing section;
(b) a clamping section having first and second optic fiber restraining members and a splice restraining member overlying respective ones of the first and second optic fiber receiving sections and the optic fiber splicing section,
   wherein the clamping section is movable between an optic fiber receiving position whereby optic fibers can be inserted into respective optic fiber receiving sections so that optic fiber cores of said optic fibers are in optical communication in the splicing section, and an optic fiber securing position whereby said optic fibers are held by frictional engagement between said optic fiber receiving sections and said restraining members.

Preferably, the housing member includes a plurality of spacers which support the clamping section in the optic fiber receiving position, said spacers shear off as the clamping section is forced towards the splicing position.

Preferably, the clamping section includes an outer clamping member arranged to translate between an optic fiber receiving position overlying the first and second optic fiber restraining members and the splice restraining member, and an optic fiber securing position bearing against the first and second optic fiber restraining members and the splice restraining member so as to force them towards the splicing position.

Preferably, the apparatus includes a preliminary clamp for securing the first optic fiber in the first optic fiber receiving section.

In accordance with another aspect of the invention, there is provided a method for mechanically splicing two optic fibers using the above-described apparatus, including the steps of:
(a) inserting a first one of said optic fibers into a first one of said optic fiber receiving sections;
(b) inserting a second one of said optic fibers into a second one of said optic fiber receiving sections so that the optic fibers are in optical communication in the splicing section; and
(c) moving the clamping section from the optic fiber receiving position towards the optic fiber securing position.

Advantageously, the above-described apparatus is able to effect a mechanical fiber splice using minimal tools.

Advantageously, the above-described apparatus effects a mechanical fiber splice with minimal waste and throw away components.

### BRIEF DESCRIPTION OF THE DRAWINGS

Preferred embodiments of the present invention are hereafter described, by way of non-limiting example only, with reference to the accompanying drawing in which:

FIG. 1 is a side perspective view of an apparatus for mechanically splicing two optic fibers;

FIG. 2 is an exploded view of the apparatus shown in FIG. 1;

FIG. 3 is another exploded view of the apparatus shown in FIG. 1;

FIG. 4 is a top perspective view of a part of the apparatus shown in FIG. 1;

FIG. 5a is a top view of the apparatus shown in FIG. 1;

FIG. 5b is a section view of the apparatus shown in FIG. 5a through the line A-A;

FIG. 5c is a section view of the apparatus shown in FIG. 5a through the line B-B;

FIG. 6 is a side perspective view of the apparatus shown in FIG. 6 arranged in another condition of use;

FIG. 7a is a top view of the apparatus shown in FIG. 6;

FIG. 7b is a section view of the apparatus shown in FIG. 6a through the line C-C;

FIG. 7c is a section view of the apparatus shown in FIG. 6a through the line D-D;

FIG. 8 is a side perspective view of the apparatus shown in FIG. 6 arranged in yet another condition of use;

FIG. 9a is a top view of the apparatus shown in FIG. 8;

FIG. 9b is a section view of the apparatus shown in FIG. 9a through the line E-E; and

FIG. 9c is a section view of the apparatus shown in FIG. 9a through the line F-F.

### DETAILED DESCRIPTION OF PREFERRED EMBODIMENTS OF THE INVENTION

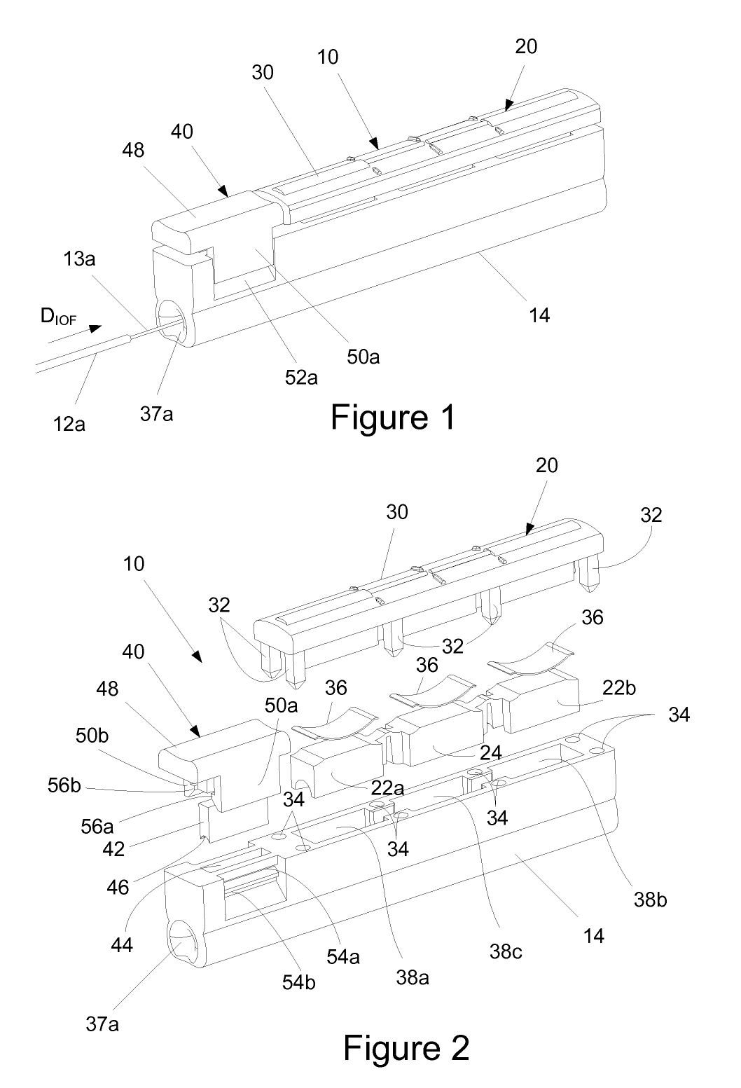

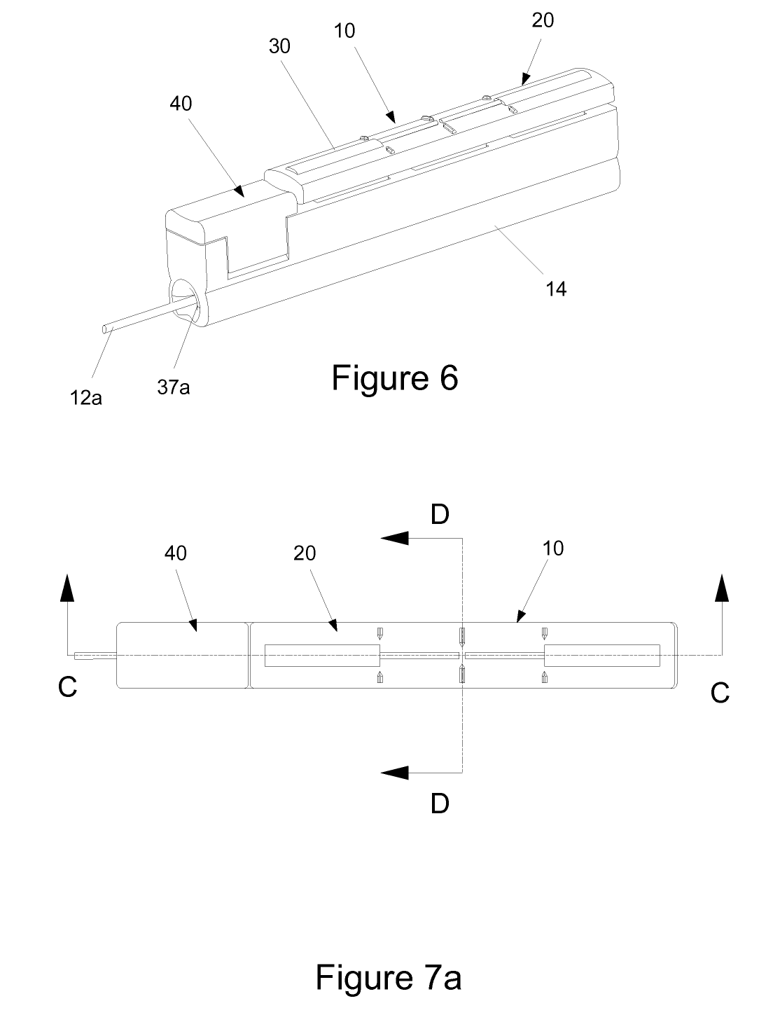

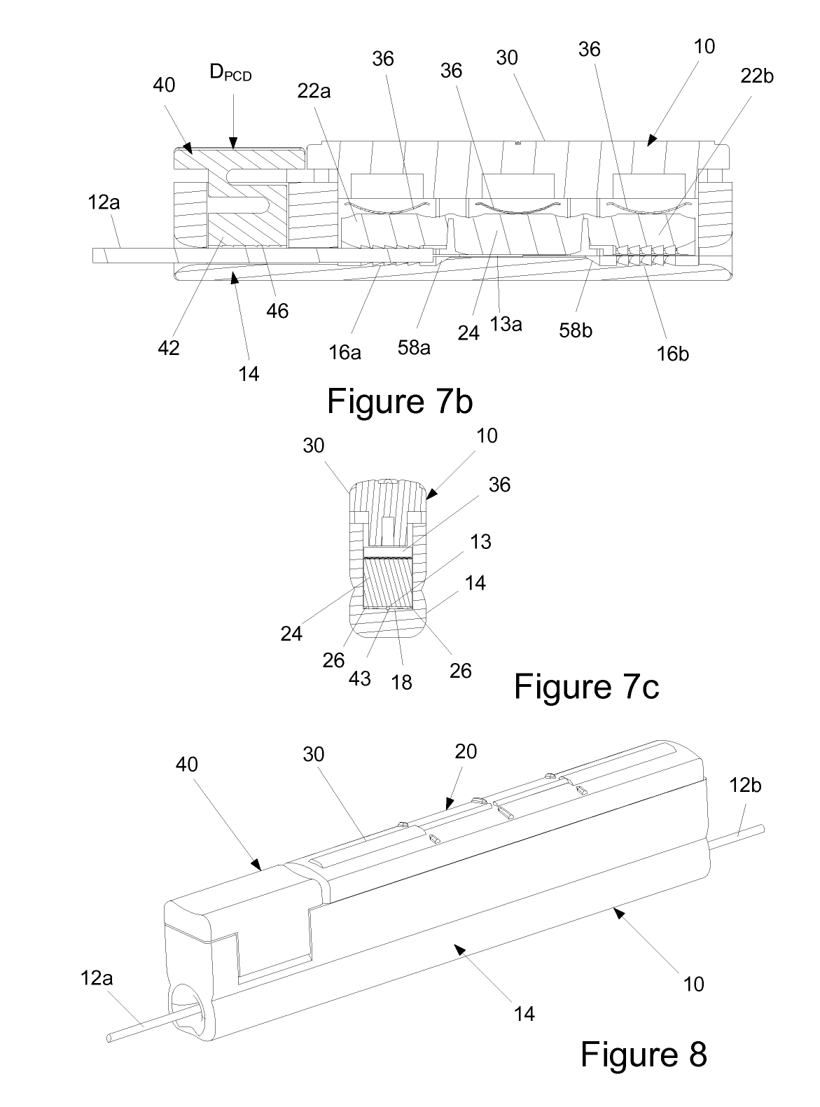

The apparatus 10 shown in FIGS. 1 to 9c is used to mechanically splice two optic fibers 12a, 12b. The apparatus 10 includes a housing member 14 having opposed first and second optic fiber receiving sections 16a, 16b separated by an optic fiber splicing section 18. The apparatus 10 also includes a clamping section 20 having first and second optic fiber restraining members 22a, 22b and a splice restraining member 24 overlying respective ones of the first and second optic fiber receiving sections 16a, 16b and the optic fiber splicing section 18. The clamping section 20 is movable between the optic fiber receiving position shown in FIG. 1, whereby optic fibers 12a, 12b can be inserted into respective optic fiber receiving sections 16a, 16b so that optic fiber cores 13a, 13b of said optic fibers are in optical communication in the splicing section 18, and the optic fiber securing position shown in FIG. 8, whereby the optic fibers 12a, 12b are held by frictional engagement between the optic fiber receiving sections 16a, 16b and the restraining members 22a, 22b, 24.

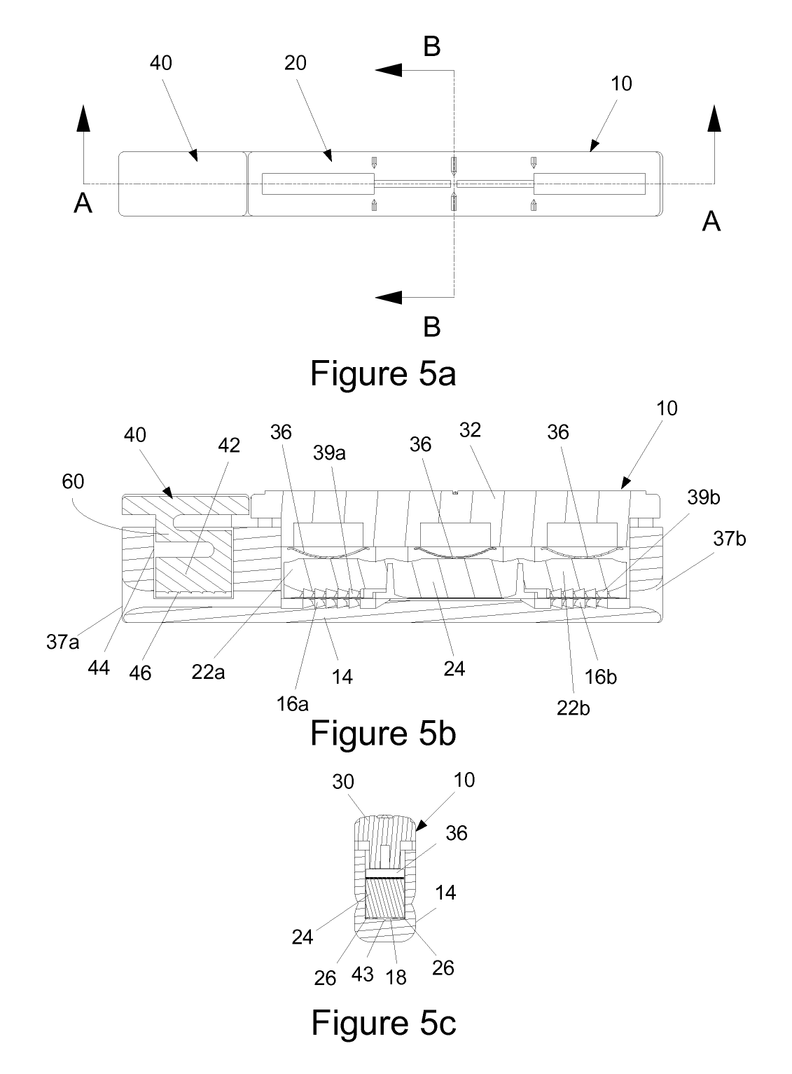

The housing member 14 includes a plurality of spacers 26 which support the clamping section 20 in the optic fiber receiving position shown in FIGS. 5b and 5c. The spacers 26 shear off as the clamping section 20 is forced towards the splicing position shown in FIG. 8. The housing member 14 includes a plurality of apertures 28 located adjacent the spacers 26. The spacers 26 fall through the apertures 28 when sheared off.

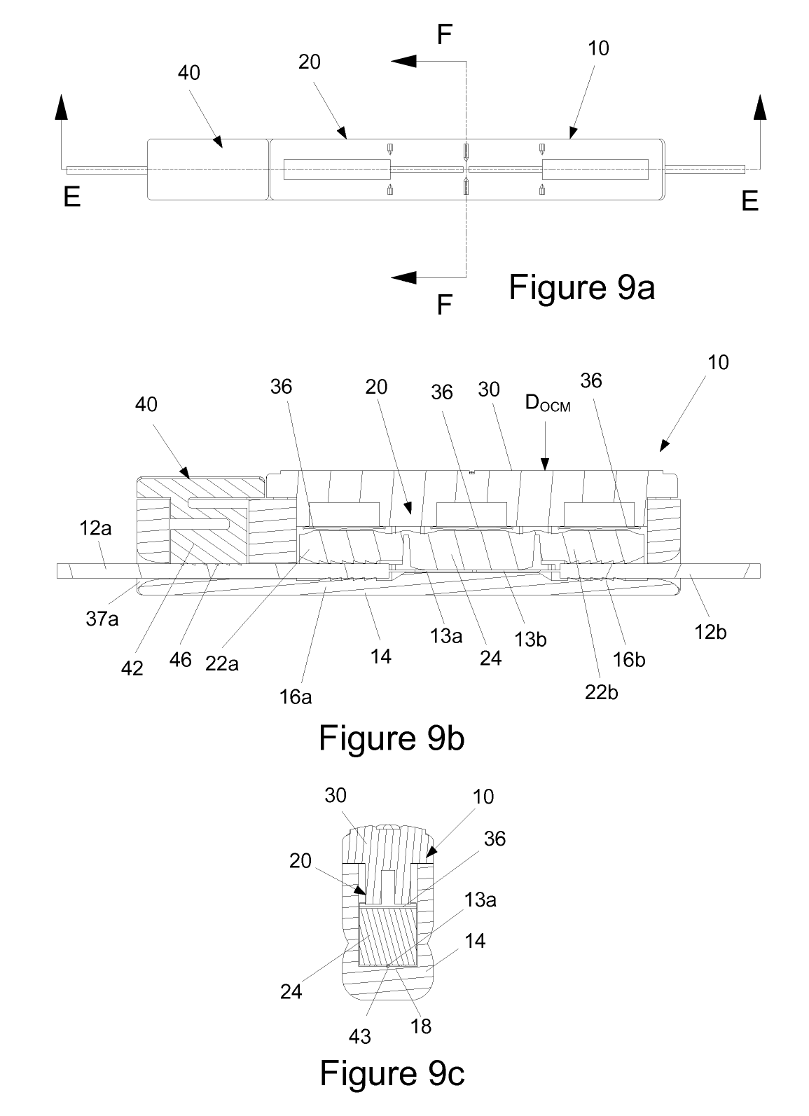

The clamping section 20 includes an outer clamping member 30 arranged to translate between the optic fiber receiving position overlying the first and second optic fiber restraining members 22a, 22b and the splice restraining member 24, as shown in FIGS. 5b and 5c, and the optic fiber securing position bearing against the first and second optic fiber restraining members 22a, 22b and the splice restraining member 24 as shown in FIGS. 9b and 9c.

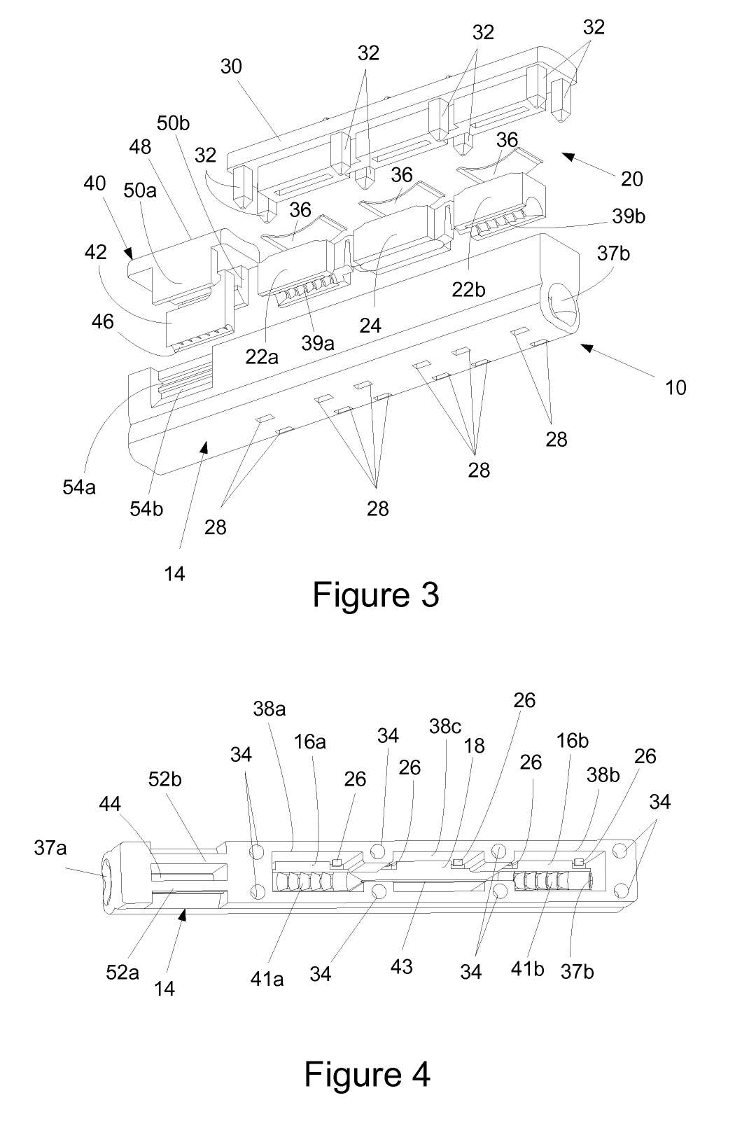

As particularly shown in FIGS. 2 and 3, the outer clamping member 30 includes a plurality of posts 32 which extend in parallel from a common side. The posts 32 are arranged to extend into corresponding slots 34 formed in the housing member 14. The posts 32 are preferably square in cross-section and the slots 34 are preferably circular. As such, when the posts 32 are forced into the slots 34, the slots 34 plastically deform and anchor the clamping member 30 in a fixed position with respect to the housing member 14. The interference fit of the square posts 32 and the round slots 34 permits the outer clamping member 30 and the housing member 14 to be assembled by pressing the member 30 into the housing 14 so that the posts 32 travel part way into the slots 34, allowing for further movement during later use.

The outer clamping member 30 and the first and second optic fiber restraining members 22a, 22b and the splice restraining member 24 are separated by resilient springs 36. The springs 36 are preferably metal leaf springs. The springs 36 resiliently bear against the members 22a, 22b, 24 when the outer clamping member 30 moves towards the optic fiber securing position and thereby force the members 22a, 22b, 24 to resiliently engage respective sections 16a, 16b, 18 of the housing member 14.

As particularly shown in FIGS. 2 to 4, the first and second optic fiber restraining members 22a, 22b and the splice restraining member 24 are respectively seated in receptacles 38a, 38b, 38c of the housing member 14. The receptacles 38a, 38b, 38c guide translation of the members 22a, 22b, 24 and inhibit lateral movement.

The first and second optic fiber restraining members 22a, 22b and the splice restraining member 24 are formed as one unit. Alternatively, members 22a, 22b, 24 are formed as individual components.

The housing member 14 includes first and second conical optic fiber receiving slots 37a, 37b for receiving optic fibers 12a, 12b and guiding them into corresponding optic fiber receiving sections 16a, 16b.

As particularly shown in FIG. 3, the first and second restraining members 22a, 22b include concave sections 39a, 39b which are shaped to engage upper sections of the optic fibers 12a, 12b. The concave sections 39a, 39b are preferably barbed so as to better engage the optic fibers 12a, 12b and thereby inhibit longitudinal movement when they are arranged in the optic fiber securing position. The barbed concave sections 39a, 39b resiliently bear against and at least partially deform the optic fibers 12a, 12b.

Similarly, as shown in FIG. 4, the first and second receiving sections 16a, 16b include concave sections 41a, 41b which are shaped to engage lower sections of the optic fibers 12a, 12b. The concave sections 41a, 41b are preferably barbed so as to better engage the optic fibers 12a, 12b and thereby inhibit longitudinal movement when they are arranged in the optic fiber securing position. The barbed concave sections 41a, 41b resiliently bear against and at least partially deform the optic fibers 12a, 12b.

The splicing section 18 preferably includes index matching gel. Further, the splicing section includes a “V” shaped groove 43 for receiving and aligning optic fibers cores of the first and second optic fibers

The apparatus 10 includes a preliminary clamp 40 for securing the first optic fiber 12a in the first optic fiber receiving section 16a. As particularly shown in FIGS. 2 and 3, the preliminary clamp 40 includes a preliminary restraining member 42 that extends into a clamping slot 44 which provides access to the optic fiber 12a. The preliminary restraining member 42 includes a concave mating surface 46, shaped to at least partially engage an upper section of the optic fiber 12a. The concave mating surface 46 is barbed to provide improved grip on the optic fiber 12a. The barbed mating surface 46 resiliently bear against and at least partially deform the optic fibers 12a, 12b.

The preliminary clamp 40 also includes a finger engaging section 48 and two male clamping members 50a, 50b extending in parallel therefrom over outer side sections 52a, 52b of the housing member 14. The outer side sections 52a, 52b of the housing member 14 include two pairs of female slots 54a, 54b arranged for engagement the male clamping members 50a, 50b.

The preliminary clamp 40 can be forced in direction D_{PCD} so as to force the restraining member 42 to bear against the optic fiber 12a. In doing so, the male clamping members 50a, 50b are forced downwards and resiliently apart over the leading chamfered edges of the first pair of slots 54a. Lugs 56a, 56b of the male clamping members 50a, 50b snap into the first pair of slots 54a when the male clamping members pass over the leading edge of the first pair of slots 54a. The restraining member 42 is thereby resiliently held in position.

Further movement of the preliminary clamp 40 in the direction D_{PCD} causes the male clamping members 50a, 50b to move downwards and resiliently apart over the leading chamfered edges of the second pair of slots 54b. Lugs 56a, 56b of the male clamping members 50a, 50b snap into the second pair of slots 54b when the male clamping members pass over the leading edge of the slots 54b. The restraining member 42 is thereby resiliently held in position under greater force.

In the first position, the preliminary clamp 40 forms the top of the slot 37a for the first fiber 12a to enter. Once the first fiber 12a is inserted, the preliminary clamp 40 is pushed in direction D_{PCD} to the second position to hold the first fiber 12a in place. In doing so, the second fiber 12b can be inserted into the slot 37b without disturbing the placement of the first fiber 12a. As particularly shown in FIG. 5b, the preliminary restraining member 42 is coupled to the finger engaging section 48 by a resilient connector 60. The preliminary restraining member 42, finger engaging section 48 and the resilient connector 60 combine to form an “S” shape spring which allows the movement of the top of the component to be greater than the actual clamping section but still applying a light clamping force.

The apparatus 10 can be used to mechanically splicing two optic fibers by performing the following method steps:
(a) inserting the first optic fiber 12a into the first optic fiber receiving section 16a until the buffer engages the necked section 58a of the receiving section 16a;
(b) securing the first optic fiber 12a in position by pressing the preliminary clamp 40 to the second clipping position;
(c) inserting the second optic fiber 12b into the second optic fiber receiving section 16b so that optic fiber cores 13a, 13b of the optic fibers 12a, 12b are in optical communication in the splicing section 18; and
(d) moving the clamping section 20 from the optic fiber receiving position towards the optic fiber securing position.

By performing the above described steps, a technician can effect mechanical fiber splicing between two optic fibers 12a, 12b.

Many modifications will be apparent to those skilled in the art without departing from the scope of the present invention

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

### LIST OF PARTS

10 Apparatus
12a, 12b Optic fiber
13a, 13b Optic fiber core
14 Housing member
16a, 16b Optic fiber receiving section
18 Optic fiber splicing section
20 Clamping section
22a, 22b Optic fiber restraining member
24 Splice restraining member
26 Spacer
28 Aperture
30 Outer clamping member
32 Post
34 Slot
36 Spring
37a, 37b Slot
38a, 38b, 38c Receptacles
39a, 39b Concave surface
40 Preliminary clamp
41a, 41b Concave surface
42 Preliminary restraining member
43 Groove
44 Clamping slot
46 Convex clamping surface
48 Finger engaging section
50a, 50b Male clamping members
52a, 52b Side of housing member
54a, 54b Pair of clamping slots
56a, 56b Lugs
58a, 58b Necked section
60 Resilient connector

1. Apparatus for mechanically splicing two optic fibers, comprising:
(a) a housing member having opposed first and second optic fiber receiving sections separated by an optic fiber splicing section;
(b) a clamping section having first and second optic fiber restraining members and a splice restraining member overlying respective ones of the first and second optic fiber receiving sections and the optic fiber splicing section,
wherein the clamping section is movable between an optic fiber receiving position wherein optic fibers can be inserted into respective optic fiber receiving sections so that optic fiber cores of said optic fibers are in optical communication in the splicing section, and an optic fiber securing position wherein said optic fibers are held by frictional engagement between said optic fiber receiving sections and said restraining members.

2. The apparatus claimed in claim 1, wherein the housing member includes a plurality of spacers which support the clamping section in the optic fiber receiving position, said spacers shear off as the clamping section is forced towards the splicing position.

3. The apparatus claimed in claim 1, wherein the clamping section includes an outer clamping member arranged to translate between an optic fiber receiving position overlying the first and second optic fiber restraining members and the splice restraining member, and an optic fiber securing position bearing against the first and second optic fiber restraining members and the splice restraining member so as to force them towards the splicing position.

4. The apparatus claimed in claim 3, wherein the outer clamping member includes a plurality of posts arranged to translate along corresponding slots formed in the housing member.

5. The apparatus claimed in claim 4, wherein the posts are substantially square in cross-section and the slots are substantially circular.

6. The apparatus claimed in claim 4, wherein the outer clamping member is secured in the optic fiber securing position by frictional engagement between the posts and the slots.

7. The apparatus claimed in claim 3, wherein the outer clamping member and the first and second optic fiber restraining members and the splice restraining member are separated by resilient springs.

8. The apparatus claimed in claim 1, wherein the first and second optic fiber restraining members and the splice restraining member are seated in receptacles in the lower housing member.

9. The apparatus claimed in claim 1, wherein the first and second optic fiber restraining members and the splice restraining member are formed as one unit.

10. The apparatus claimed in claim 1, including a preliminary clamp for securing the first optic fiber in the first optic fiber receiving section.

11. The apparatus claimed in claim 10, wherein the preliminary clamp includes an “S” shaped spring for resiliently engaging the first optic fiber.

12. The apparatus claimed in claim 1, wherein the first and second restraining members are barbed for gripping respective first and second optic fibers.

13. The apparatus claimed in claim 1, wherein the first and second receiving sections are barbed for gripping respective first and second optic fibers.

14. The apparatus claimed in claim 1, wherein the splicing section includes index matching gel.

15. The apparatus claimed in claim 1, wherein the splicing section includes a “V” shaped groove for receiving and aligning optic fibers cores of the first and second optic fibers.

16. A method for mechanically splicing two optic fibers comprising:
(a) inserting a first one of said optic fibers into a first one of two optic fiber receiving sections or a housing;
(b) inserting a second one of said optic fibers into a second one of said two optic fiber receiving sections so that the optic fibers are in optical communication in the splicing section or the housing; and
(c) moving a clamping section relative to the housing from aoptic fiber receiving position towards a optic fiber securing position.
